(19) United States
(12) Patent Application Publication
(10) Pub. No.: US 2026/0227991 A1
(43) Pub. Date: Aug. 6, 2026

(54) DISTRIBUTED COMPUTING ENVIRONMENT UPDATE SCHEDULING SYSTEM AND DISTRIBUTED COMPUTING ENVIRONMENT UPDATE SCHEDULING METHOD

(71) Applicant: Hitachi, Ltd., Tokyo (JP)

(72) Inventors: Rina ANDO, Tokyo (JP); Nao NISHIJIMA, Tokyo (JP)

(21) Appl. No.: 19/304,724

(22) Filed: Aug. 20, 2025

(30) Foreign Application Priority Data
Feb. 5, 2025 (JP) 2025-017708

(51) Int. Cl. G06F 8/65

(52) U.S. Cl. CPC G06F 8/65

(57) ABSTRACT

A distributed computing environment update scheduling system monitors whether or not the function provided to an application is updated, and determines, when detecting the update of the function, whether a running job and a standby job have compatibility that can be normally executed in the updated environment of a plurality of computer nodes to apply update of a function in the computer nodes. The distributed computing environment update scheduling system generates an execution schedule of the update task in the plurality of computer nodes based on a determination result as to whether the running job and the standby job have the compatibility.

### CROSS-REFERENCE TO RELATED APPLICATION

The present application claims priority from Japanese application JP2025-017708, filed on February 5, 2025, the content of which is hereby incorporated by reference into this application.

### BACKGROUND OF THE INVENTION

### Field of the Invention

The present invention relates to a distributed computing environment update system and a distributed computing environment update method.

### Description of the Related Art

In recent years, machine learning processing (ML processing, in particular model learning) handles a large amount of data, and thus is generally executed using a distributed computing environment including a plurality of nodes. The technology related to the machine learning processing is evolving with rapid advancement and the frequency of updating an application, a library, and an environment for executing an application such as hardware is extremely high. These updates are essential for improving the accuracy of the generated learning model and realizing new functions.

However, when the application or the execution environment is updated, a problem of compatibility between the application and the execution environment arises, and there is a risk that the operation of the entire system becomes unstable. In particular, in a distributed computing environment, a plurality of nodes and components depend on each other, and hence it is likely to be difficult to find a cause when a failure occurs. Therefore, a mechanism for updating the execution environment in accordance with the evolution of the ML technology while appropriately securing the compatibility between the application and the execution environment so as not to cause such a failure is required.

Therefore, for example, US Patent No. 9342298 discloses a method of dynamically checking compatibility of a library at the time of software upgrade or cluster configuration, and updating an execution environment while maintaining stability, thereby securing compatibility of applications in a distributed computing environment.

### SUMMARY OF THE INVENTION

However, in the technology described in US Patent No. 9342298 described above, in a case where the execution environment is updated at a high frequency, the machine learning processing requiring a long time (e.g., three or more days) is frequently stopped or interrupted by the update, and the time until the completion of the entire processing is significantly extended. As described above, it is difficult to update the environment appropriately and efficiently during the operation of the distributed computing environment.

The present invention has been made in view of the above points, and an object of the present invention is to update an environment appropriately and efficiently during operation of a distributed computing environment.

In order to achieve the above object, the present invention provides a distributed computing environment update scheduling system for generating a schedule for executing an update task for updating an environment of a plurality of computer nodes to which a job including a task related to an application to be executed by a computer is allocated and executed by the plurality of computer nodes to apply update of a function provided to the application, in which a processor of the distributed computing environment update scheduling system is configured to:

monitor whether or not the function is updated,

determine, when detecting the update of the function, whether a running job and a standby job have compatibility that can be normally executed in the updated environment in the plurality of computer nodes; and

generate an execution schedule of the update task in the plurality of computer nodes based on a determination result as to whether the running job and the standby job have the compatibility.

According to the present invention, for example, the environment can be appropriately and efficiently updated during the operation of the distributed computing environment.

### BRIEF DESCRIPTION OF THE DRAWINGS

FIG. 1 is a diagram illustrating an example of a configuration of a distributed computing system according to an embodiment;

FIG. 2 is a diagram illustrating an outline of a distributed computing environment update scheduling processing in the distributed computing system according to the embodiment;

FIG. 3 is a diagram illustrating an example of a hardware configuration of a computer according to the embodiment;

FIG. 4 is a flowchart illustrating an example of distributed computing environment update processing according to an embodiment;

FIG. 5 is a flowchart illustrating an example of processing an update task priority execution node selection processing according to the embodiment;

FIG. 6 is a flowchart illustrating an example of an update task execution processing according to the embodiment;

FIG. 7 is a diagram illustrating an outline of scheduling of an update task according to the embodiment;

FIG. 8 is a flowchart illustrating an example of a new job scheduling processing according to the embodiment; and

FIG. 9 is a diagram illustrating an outline of scheduling of a new task according to the embodiment.

### DESCRIPTION OF THE PREFERRED EMBODIMENTS

Hereinafter, embodiments of the present invention will be described with reference to the drawings.

### Configuration of Distributed Computing System "S" According to Embodiment

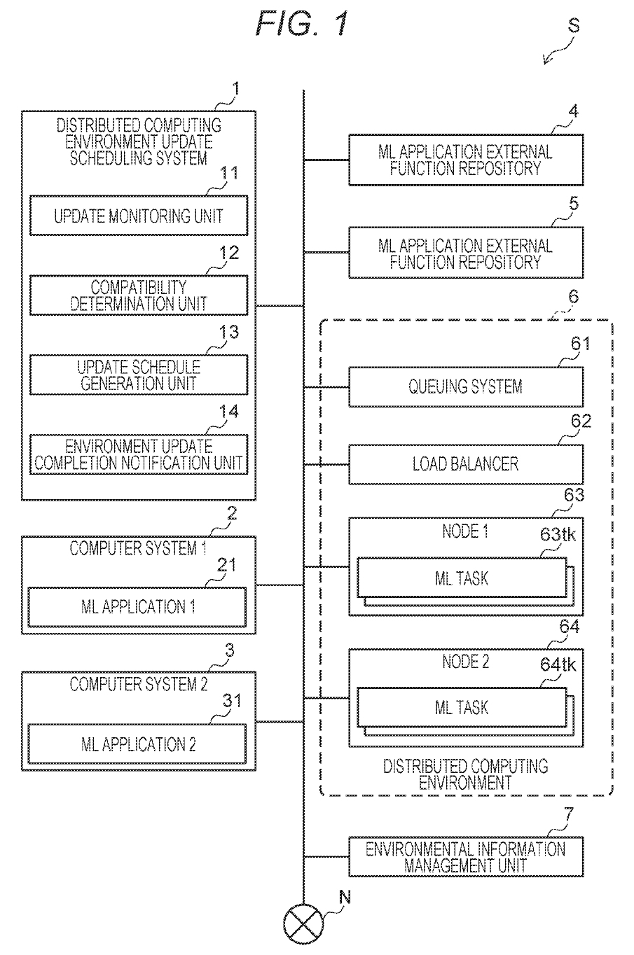

FIG. 1 is a diagram illustrating an example of a configuration of a distributed computing system S according to an embodiment. The distributed computing system S generates a schedule for executing an update task for updating the environment of the nodes 63 and 64, to which a job including a task related to the application is allocated and executed, to apply the update of the function provided to the application.

The distributed computing system S includes a distributed computing environment update scheduling system 1, computer systems 2 and 3, machine learning processing (ML) application external function repositories 4 and 5, a distributed computing environment 6, and an environmental information management unit 7. In the distributed computing system S, the distributed computing environment update scheduling system 1, the computer systems 2 and 3, the ML application external function repositories 4 and 5, the distributed computing environment 6, and the environmental information management unit 7 are connected to a network N.

The distributed computing environment update scheduling system 1 includes an update monitoring unit 11, a compatibility determination unit 12, an update schedule generation unit 13, and an environment update completion notification unit 14.

In the computer systems 2 and 3, each is a computer having a processor such as a CPU that executes the ML applications 21 and 31. The ML applications 21 and 31 cause the nodes 63 and 64 of the distributed computing environment 6 to execute the ML tasks 63tk and 64tk constituting the ML job related to the ML processing instructed by the user to perform machine learning, thereby generating a learning model. The ML applications 21 and 31 are an example of an application that causes the distributed computing environment 6 to execute a task.

The ML application external function repositories 4 and 5 accumulate modules of external functions provided to the ML application to be executed in the distributed computing environment 6.

The distributed computing environment 6 includes a queuing system 61, a load balancer 62, and the nodes 63 and 64. The queuing system 61 is a queuing system capable of managing a schedule of a task such as Kueue. The queuing system 61 controls the execution schedule of the task by registering the task in the queue in the execution order. The queuing system 61 can change the execution order by giving priority to jobs. That is, the queuing system 61 can give priority to the running task and the standby task and review the schedule after scheduling the task by default.

In addition, in the queuing system 61, in addition to the ML tasks 63tk and 64tk, an update task for updating an external function provided from the ML application external function repositories 4 and 5 to the ML applications 21 and 31 by being applied to the nodes 63 and 64 is registered.

The nodes 63 and 64 are computer nodes having a processor such as a CPU that executes one or more ML tasks 63tk and 64tk and an update task according to an execution schedule controlled by the queuing system 61.

The environment information management unit 7 acquires and manages environmental information including the configuration of the distributed computing environment 6, the execution status of the ML tasks 63tk and 64tk and the update task in each of the nodes 63 and 64, and the like.

Note that in the present embodiment, two computer systems 2 and 3 and two ML application external function repositories 4 and 5 are illustrated, but the number of computer systems and ML application external function repositories is not limited to two. Furthermore, in the present embodiment, two nodes 63 and 64 are illustrated, but the number of nodes is not limited to two.

### Outline of Processing of Embodiment

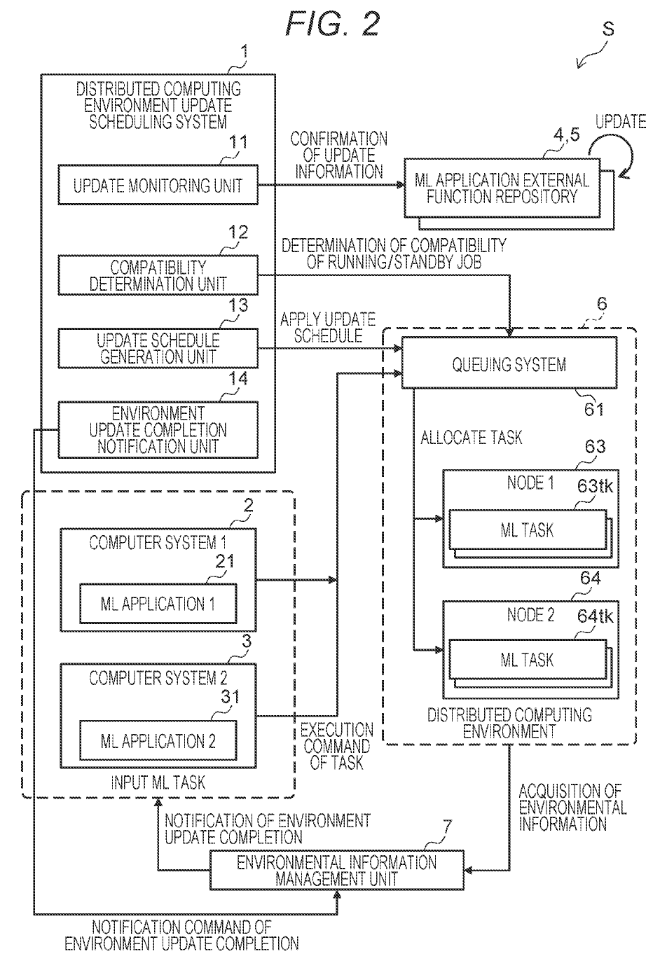

FIG. 2 is a diagram illustrating an outline of a distributed computing environment update scheduling processing in the distributed computing system S according to the embodiment.

The update monitoring unit 11 periodically accesses the ML application external function repositories 4 and 5 and confirms whether or not the external functions in the ML application external function repositories 4 and 5 have been updated.

The compatibility determination unit 12 refers to the queuing system 61 of the distributed computing environment 6 and determines compatibility of the running and standby ML tasks scheduled by the queuing system 61 on a job-by-job basis. To “have compatibility to the execution environment before the execution of the update task" indicates an execution environment in which the nodes 63 and 64 before execution of the update task for updating the external function of the ML application can normally execute the ML tasks 63tk and 64tk. To “have compatibility to the execution environment after the execution of the update task" indicates an execution environment in which the nodes 63 and 64 after execution of the update task for updating the external function of the ML application can normally execute the ML tasks 63tk and 64tk.

The update schedule generation unit 13 generates the execution schedule of the update task for updating the execution environment in each of the nodes 63 and 64 based on the determination result of the compatibility of the running and standby ML tasks 63tk and 64tk determined by the compatibility determination unit 12. The update schedule generation unit 13 schedules the update task while maintaining the balance of resources in view of the statuses of the running and standby ML tasks, the resource load, and the compatibility of the ML task with respect to the environment after the update.

Then, the update schedule generation unit 13 notifies the queuing system 61 of the generated execution schedule. The queuing system 61 stores the update task in the queue according to the execution schedule of the update task generated by the update schedule generation unit 13.

The environment update completion notification unit 14 commands the environmental information management unit 7 to notify the computer systems 2 and 3 of the environment update completion notification when the update of the environment of the distributed computing environment 6 is normally completed by the execution of the update task in each of the nodes 63 and 64.

The ML applications 21 and 31 command the queuing system 61 to execute a task (ML task) of the ML application. The queuing system 61 allocates the ML tasks 63tk and 64tk and the update task by storing them in the queue for each of the nodes 63 and 64 in the execution order according to the task execution command from the ML applications 21 and 31.

The load balancer 62 monitors the progress status of the ML tasks 63tk and 64tk and the update task, and levels the resource load as necessary. If the balance of resource use is deteriorated, the load balancer changes the distribution of the ML tasks 63tk and 64tk to other nodes while looking at the completion status of the update task of each of the nodes 63 and 64 and the load balance of the resource. When changing the distribution of the ML tasks 63tk and 64tk to other nodes, the load balancer may interrupt so as not to be later than the order before the change.

Each of the nodes 63 and 64 sequentially extracts the allocated ML tasks 63tk and 64tk and the update task from the queue and executes the tasks.

The distributed computing environment 6 manages environmental information including the configuration of the distributed computing environment 6, the execution status of the ML tasks 63tk and 64tk and the update task in each of the nodes 63 and 64, and the like. The distributed computing environment 6 passes the environmental information to the environmental information management unit 7 in response to a request from the environmental information management unit 7. When the computer systems 2 and 3 are notified that the update of the environments of the nodes 63 and 64 has been completed by the execution of the update task, the developer can code the ML applications 21 and 31 to use the functions after the update.

### Hardware of Computer 300

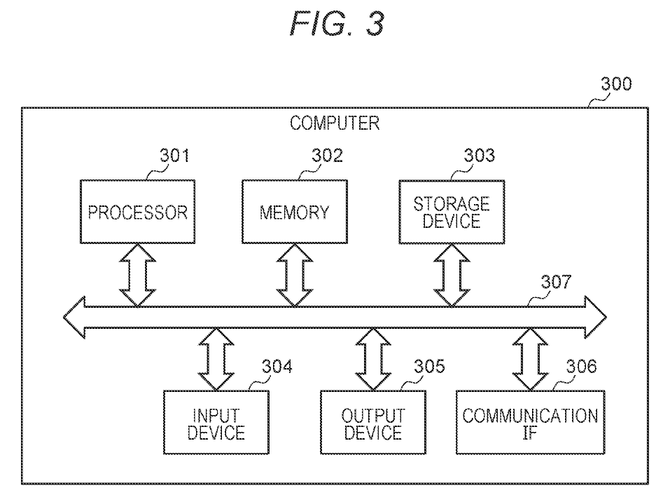

FIG. 3 is a diagram illustrating an example of a hardware configuration of a computer 300 according to the embodiment. The computer 300 realizes each unit of the distributed computing environment update scheduling system 1, the computer systems 2 and 3, and the nodes 63 and 64 by executing a predetermined program.

The computer 300 includes a processor 301 including a CPU, a memory 302, a storage device 303, an input device 304, an output device 305, and a communication I/F 306 connected to one another via an internal communication line 307 such as a bus.

The processor 301 controls the operation of the entire computer 300, and implements each functional unit by executing a predetermined program in cooperation with the memory 302. The memory 302 includes, for example, a volatile semiconductor memory, and is used as a work memory of the processor 301. The storage device 303 includes one or more hard disk devices, a Solid State Drive (SSD), or a large-capacity nonvolatile storage device such as a flash memory and is used to hold various programs and data for a long period of time. The executable program stored in the storage device 303 is loaded into the memory 302 when the computer 300 is started or when necessary and is executed by the processor 301.

Note that the executable program may be recorded in a non-transitory recording medium, read from the non-transitory recording medium by a medium reading device, and loaded into the memory 302. Alternatively, the executable program may be acquired from an external computer via a network and loaded into the memory 302.

The input device 304 includes a keyboard, a pointing device such as a mouse, and the like, and is used by the user to input various instructions and information to the computer 300. The output device 305 includes, for example, a display device such as a liquid crystal display or an organic Electro Luminescence (EL) display, or an audio output device such as a speaker, and is used to present necessary information to the user when necessary.

The communication I/F 306 is an interface device for connecting the computer 300 to each network in the system or for communicating with another computer. The communication I/F 306 includes, for example, a Network Interface Card (NIC) such as a wired Local Area Network (LAN) or a wireless LAN.

### Distributed Computing Environment Update Processing According to Embodiment

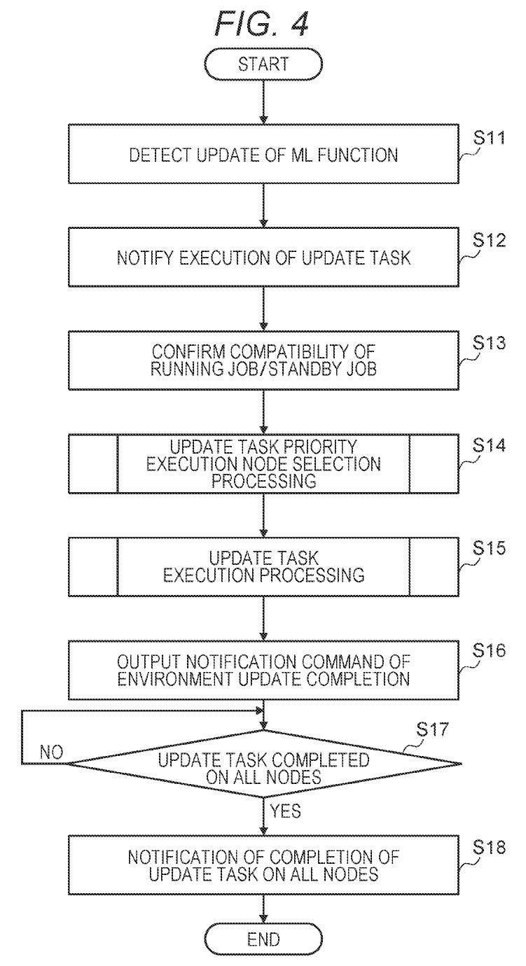

FIG. 4 is a flowchart illustrating an example of distributed computing environment update processing according to an embodiment. The distributed computing environment update processing is executed each time an update of an external function of an ML application used by the ML applications 21 and 31 of the computer systems 2 and 3 is detected.

First, in step S11, the update monitoring unit 11 detects the update of the external function of the ML application in the ML application external function repositories 4 and 5. Next, in step S12, the update monitoring unit 11 notifies the user of the update of the external function (execution of the update task) in the distributed computing environment 6.

Next, in step S13, the compatibility determination unit 12 checks compatibility between the running job (ML tasks 63tk and 64tk included in the running job) and the standby job (ML tasks 63tk and 64tk included in the standby job) by the method disclosed in US Patent No. 9342298. For example, the compatibility determination unit 12 gives a compatible label to the job determined to have compatibility in step S13 on a job-by-job basis.

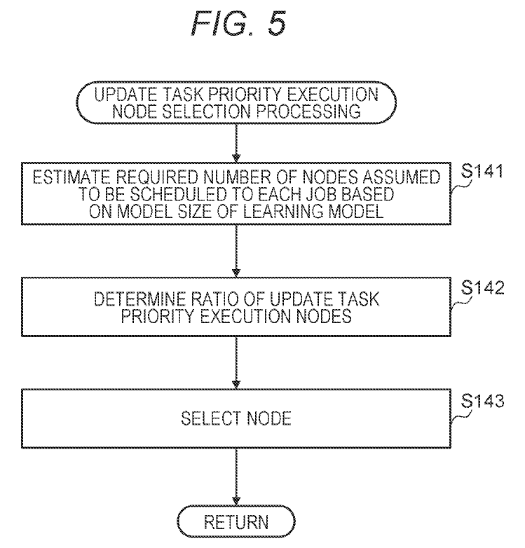

Next, in step S14, the update schedule generation unit 13 executes update task priority execution node selection processing. Details of the update task priority execution node selection processing will be described later with reference to FIG. 5.

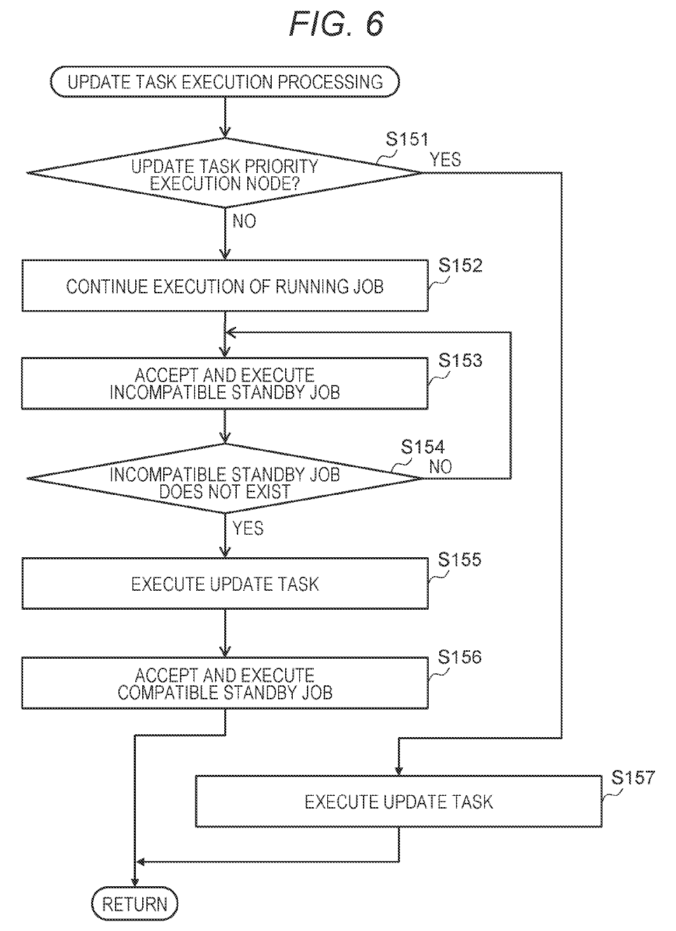

Next, in step S15, the update schedule generation unit 13 executes update task execution processing. Details of the update task execution processing will be described later with reference to FIG. 6.

Next, in step S16, the environment update completion notification unit 14 outputs a notification command of environment update completion to the environmental information management unit 7. The environmental information management unit 7 periodically acquires environmental information from the distributed computing environment 6, and acquires the execution status of the update task in each of the nodes 63 and 64.

Next, in step S17, the environmental information management unit 7 determines whether the execution of the update task has been completed in all the nodes 63 and 64. When the execution of the update task is completed in all the nodes 63 and 64 (step S17 YES), the environmental information management unit 7 proceeds to step S18. On the other hand, when the execution of the update task has not been completed in all the nodes 63 and 64 (step S17 NO), the environmental information management unit 7 repeats step S17.

In step S18, the environmental information management unit 7 notifies the computer systems 2 and 3 of the completion of the update task in all the nodes 63 and 64.

### Update Task Priority Execution Node Selection Processing According to Embodiment

FIG. 5 is a flowchart illustrating an example of update task priority execution node selection processing according to the embodiment. The update task priority execution node selection processing is called in step S14 of the distributed computing environment update processing (FIG. 4). The update task priority execution nodes are the nodes 63 and 64 on which an update task is executed without waiting for completion of another running job and a standby job.

First, in step S141, the update schedule generation unit 13 estimates the required number of nodes assumed to be scheduled for each job based on the model size (number of parameters) of the learning model to be generated and the information regarding the resource status of the nodes 63 and 64. It is assumed that the information regarding the resource status includes, for example, CPU × 2, GPU × 2, and the memory amount = 40GB per node 63 or 64. For example, when the model size of the learning model to be generated is 80B, the required number of nodes = the number of parameters of the model/the memory amount per GPU = 80/20 = 4 nodes. Furthermore, for example, when the model size of the learning model to be generated is 60B, the required number of nodes = the number of parameters of the model/the memory amount per GPU = 60/20 = 3 nodes.

Next, in step S142, the update schedule generation unit 13 determines the ratio of nodes that preferentially execute the update task. That is, the ratio of nodes that preferentially execute the update task is determined from the required number of nodes of the compatible running and standby jobs and the required number of nodes required by the incompatible running and standby jobs. For example, in a case where the required number of nodes required by the compatible job is 2 and the required number of nodes required by the incompatible job is 3, the ratio of nodes that preferentially execute the update task is 2/(2 + 3) = 2/5.

Next, in step S143, the update schedule generation unit 13 selects, for example, node to which a compatible job is scheduled for the update task priority execution node from among the nodes executing the compatible job, with the number obtained from the ratio of nodes determined in step S142 as an upper limit. The update schedule generation unit 13 gives a tag to information related to the update task priority execution node. For example, in a case where the number of update task priority execution nodes has not reached the number obtained from the ratio of nodes determined in step S142, nodes for which incompatible jobs are scheduled are randomly selected to reach this number.

### Update Task Execution Processing According to Embodiment

FIG. 6 is a flowchart illustrating an example of update task execution processing according to the embodiment. The update task execution processing is executed in parallel for all nodes of the distributed computing environment 6.

First, in step S151, the node (one of the nodes 63 and 64) determines whether a tag determined to be “update task priority execution node” in step S143 (FIG. 5) is given to the corresponding node in the distributed computing environment 6. In a case where a tag is given (step S151 YES), the update schedule generation unit 13 proceeds to step S157 for the corresponding node. On the other hand, in a case where no tag is given (step S151 NO), the update schedule generation unit 13 proceeds to step S152 for the corresponding node.

In step S152, the node continues execution of the running job in the corresponding node. Next, in step S153, since the execution of the job in step S152 has terminated, the node accepts and executes the incompatible standby job.

Next, in step S154, the node determines whether the execution of the job in step S153 has terminated, and whether there is no incompatible standby job to be accepted next. In a case where there is no incompatible standby job to be accepted next (step S154 YES), the node proceeds to step S155. On the other hand, when there is an incompatible standby job to be accepted next (step S154 NO), the node returns the processing to step S153.

In step S155, the node executes the update task. Next, in step S156, the node accepts and executes the compatible standby job. On the other hand, in step S157, the node preferentially executes the update task.

### Outline of Scheduling of Update Task According to Embodiment

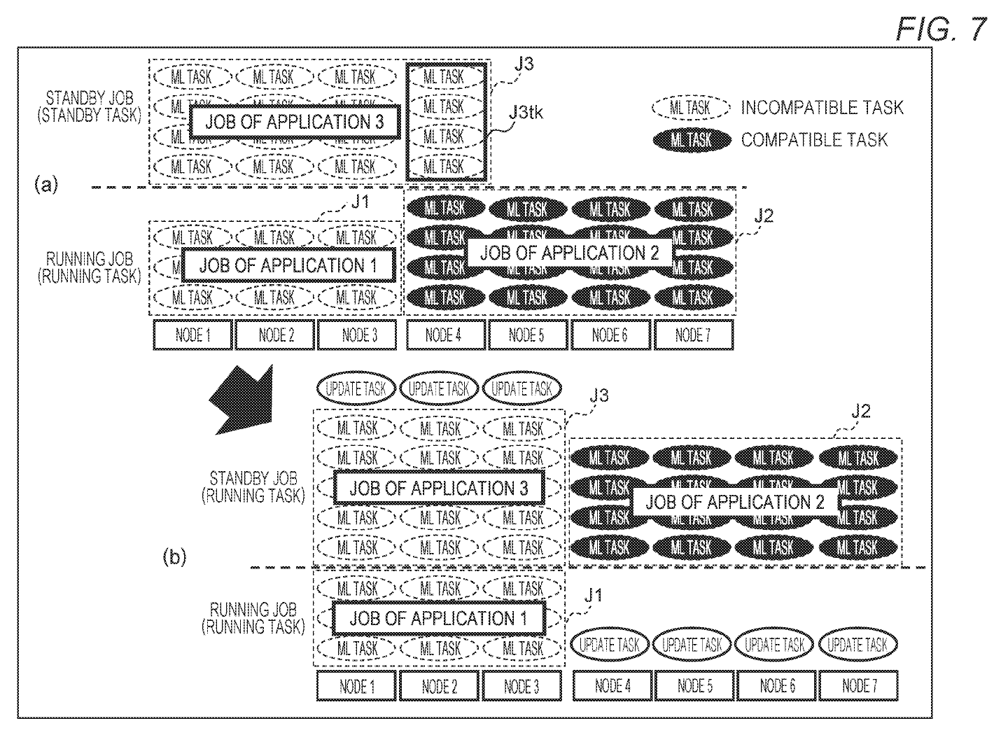

FIG. 7 is a diagram illustrating an outline of scheduling of an update task according to the embodiment. Here, “(a) before scheduling of update task” in FIG. 7 indicates that the ML task of the job J1 of the application 1 compatible with the updated environment in which the update task is executed is being executed in the nodes 1 to 3. Furthermore, “(a) before scheduling of update task” in FIG. 7 indicates that the ML task of the job J3 of the application 3 compatible with the updated environment is on standby in the nodes 1 to 4. Moreover, “(b) after scheduling of update task” in FIG. 7 indicates that the ML task of the job J2 of the application 2 that is incompatible with the updated environment is being executed in the nodes 4 to 7.

The ML task compatible with the updated environment is desirably executed in the updated environment in consideration of improvement in accuracy of the model to be generated.

Therefore, as illustrated in “(a) before scheduling of update task” of FIG. 7, the execution of the compatible ML task included in job J2 of the application 2 being executed in the nodes 4 to 7 is interrupted. Then, as illustrated in “(b) after scheduling of update task” in FIG. 7, in the nodes 4 to 7, job J2 is put in queue and on standby so that job J2 is re-executed after completion of the update task.

In addition, the ML task that is incompatible with the environment after the update is desirably executed in the environment before the update in consideration of improvement in accuracy of the model to be generated.

Therefore, as illustrated in “(a) before scheduling of update task” of FIG. 7, the scheduling of the ML task J3tk on standby in the node 4 among the incompatible ML tasks included in job J3 of the application 3 is changed. That is, as illustrated in “(b) after scheduling of update task” of FIG. 7, in the nodes 1 to 3, all the ML tasks of the job J3 are put in queue and on standby to be executed after completion of the update task. Then, after execution of all the standby ML tasks of the job J3 is completed, the update task is put in queue and on standby so as to be executed.

The distributed computing environment update scheduling system 1 optimizes and generates an execution schedule so that a running job (task), a standby job (task), and an update task are executed at appropriate timing and the loads of the nodes 1 to 7 are leveled.

Note that a Graphical User Interface (GUI) that displays FIG. 7 can also be output from a display device connected to the distributed computing environment update scheduling system 1. As a result, the user can grasp the status of the scheduling and the changes of the compatible task, the incompatible task, and the update task before and after the scheduling of the update task.

### New Job Scheduling Processing According to Embodiment

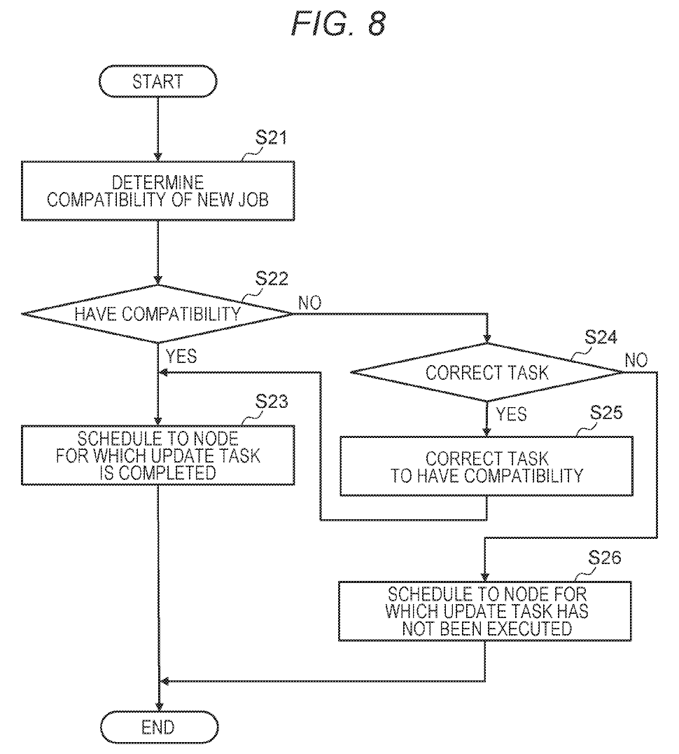

FIG. 8 is a flowchart illustrating an example of a new job scheduling processing according to the embodiment. The new job scheduling processing is processing executed when a new job arrives before the update task is completed in all the nodes 63 and 64. The new job scheduling processing causes the compatible or incompatible ML tasks 63tk and 64tk to be continuously executed based on the execution status including the presence/absence of compatibility of the existing ML tasks 63tk and 64tk in the nodes 63 and 64. In principle, the jobs including the ML tasks 63tk and 64tk executed in the nodes 63 and 64 have the execution order of “incompatible → update task → compatible”.

First, in step S21, the update schedule generation unit 13 determines compatibility of a new job. Next, in step S22, the update schedule generation unit 13 determines whether the determination result of compatibility of the new job in step S21 is compatible. When the new job is compatible (step S22 YES), the update schedule generation unit 13 proceeds to step S23. On the other hand, when the new job is incompatible (step S22 NO), the update schedule generation unit 13 proceeds to step S24.

In step S23, the update schedule generation unit 13 schedules a new task to one of the nodes 63 and 64 for which the update task has been completed. On the other hand, in step S24, the update schedule generation unit 13 inquires the user via the GUI whether to correct the task of the new job to have compatibility or execute the task in the computer nodes 63 and 64 in the environment before the update, and determines whether an instruction to correct the task has been given. When instructed to correct the task of the new job to have compatibility (step S24 YES), the update schedule generation unit 13 proceeds to step S25. On the other hand, when instructed to execute the task of the new job in the computer nodes 63 and 64 in the environment before the update (step S24 NO), the update schedule generation unit 13 proceeds to step S26.

In step S25, the update schedule generation unit 13 corrects the corresponding task to have compatibility. When step S25 is terminated, the update schedule generation unit 13 proceeds to step S23.

In step S26, the update schedule generation unit 13 schedules a new task to one of the nodes 63 and 64 for which the update task has not been executed. The new job allocated to any one of the nodes 63 and 64 in steps S23 and S26 is executed in each of the nodes 63 and 64 according to the schedule.

### Outline of Scheduling of New Task According to Embodiment

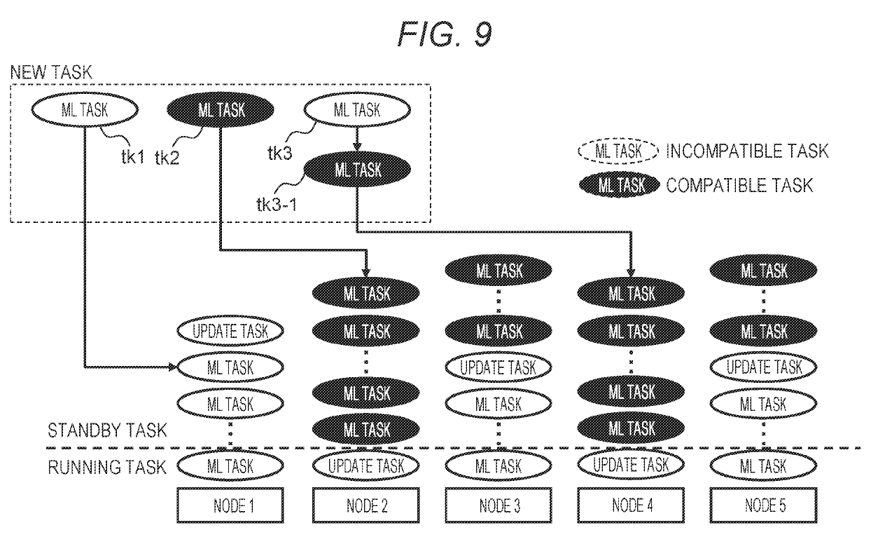

FIG. 9 is a diagram illustrating an outline of scheduling of a new task according to the embodiment.

As illustrated in FIG. 9, whether the new ML tasks tk1, tk2, and tk3 are compatible with the updated environment are confirmed. The compatible ML task tk2 is put in queue and on standby to be executed in any node in the updated environment.

Furthermore, in a case where the environment of the node is being updated, the user is notified that the environment of the corresponding node is being updated. Furthermore, regarding the new ML tasks tk1 and tk3 that are incompatible with the updated environment, the user is inquired whether or not to correct the new ML tasks that are incompatible to have compatibility. Then, according to the user selection, the ML task tk3 is corrected to the compatible ML task tk3-1, and the ML task tk3-1 is put in queue and on standby to be executed in the node after the environment update, such as the node 4. On the other hand, the ML task tk1 that has not been corrected to have compatibility is, for example, put in queue and on standby so as to interrupt before the update task and be executed as with the node 1.

Note that the GUI displaying FIG. 9 can also be output from a display device connected to the distributed computing environment update scheduling system 1. As a result, the user can grasp the scheduling situation of the new task.

### Effects of Embodiment

In the above-described embodiment, the execution schedule of the update task in the plurality of computer nodes is generated based on the determination result as to whether the running job and the standby job are compatible. Thus, during operation of the distributed computing environment, the environment can be efficiently updated without terminating the task. In addition, it is possible to avoid inefficiency that a task having compatibility with respect to the environment after the update is executed in the environment after the update after being executed in the environment before the update.

In addition, in the above-described embodiment, the priority execution computer node that interrupts the running job and executes the update task is selected based on the determination result as to whether the running job and the standby job are compatible. Therefore, execution of a compatible job in an appropriate environment can be promptly started by updating the environment in the priority execution computer node capable of updating the environment.

In addition, in the above-described embodiment, the priority execution computer node that interrupts the running job and executes the update task is selected based on the ratio of the required number of nodes. Therefore, the priority execution computer node can be appropriately selected according to the presence or absence of compatibility between the running job and the standby job and the resource status.

In addition, in the above-described embodiment, in the computer node other than the priority execution computer node, the execution of the running job is continued, and when the execution of the running job is completed, another job having no compatibility is executed. Then, when the execution of all the jobs having no compatibility is completed, the update task is executed, and when the execution of the update task is completed, another compatible job is executed. Therefore, the tasks can be continuously executed in the order of the incompatible task → the update task → the compatible task.

In addition, in the above-described embodiment, the allocation of the tasks included in the job having no compatibility that had been allocated to the priority execution computer node is changed to the computer nodes other than the priority execution computer node. Therefore, the tasks can be continuously executed in the order of the incompatible task → the update task → the compatible task.

In addition, in the above-described embodiment, whether a new task newly generated during execution of an update task in a plurality of computer nodes has compatibility is determined, and an execution schedule of the new task in the plurality of computer nodes is generated based on a determination result as to whether the new task has compatibility. Therefore, even during the execution of the update task, the new task can be appropriately allocated to any of the plurality of computer nodes.

In addition, in the above-described embodiment, when the new task has no compatibility, the user is inquired whether to correct the new task so as to be compatible. Then, when the instruction of the user to correct the new task to have compatibility is accepted, the new task is corrected to have compatibility, and the execution schedule is generated such that the new task after the correction is executed in the computer node after the execution of the update task is completed. On the other hand, when the instruction of the user to not correct the new task to have compatibility is accepted, the execution schedule is generated so as to be executed in a computer node for which the update task has not been executed. Therefore, the new task generated during the execution of the update task can be executed in any of the environment after the update after the completion of the execution of the update task and the environment before the update in which the execution of the update task has not been executed according to the user instruction, and the progress of the job including the task can be quickly completed.

In the above-described embodiment, the computer is notified that the update of the environment of the computer node has been completed by the execution of the update task. Therefore, the developer can quickly use the updated latest function when coding the application.

In addition, in the above-described embodiment, the execution schedule of the running job, the standby job, and the update task is generated so as to level the loads in the plurality of computer nodes. Therefore, the usage efficiency of the distributed computing environment can be improved, and in addition, the development efficiency of the application such as the ML application can be improved.

Furthermore, in the above-described embodiment, the application is an application that requires a long time for processing such as an ML application that executes machine learning processing. Therefore, it is possible to avoid the inconvenience that the processing of the application is frequently stopped or interrupted due to the update of the execution environment, and it is possible to prevent the time until the completion of the entire processing from being greatly delayed.

The present invention is not limited to the above-described embodiments, and includes various modified examples. For example, the embodiments described above have been described in detail for the sake of easy understanding of the present invention, and are not necessarily limited to those having all the described configurations. In addition, a part of the configuration of a certain embodiment can be replaced with a configuration of another embodiment, and the configuration of a certain embodiment can be added with the configuration of another embodiment. Furthermore, for a part of the configuration of each embodiment, other configurations can be added, deleted, or replaced. In addition, some or all of the above-described configurations, functions, processing units, processing means and the like may be realized by hardware, for example, by designing with an integrated circuit. In addition, each of the above-described configurations, functions, and the like may be realized by software by a processor interpreting and executing a program for realizing each function. Such a program is acquired via a non-transitory medium or acquired from an external device via a communication line and installed in a computer including a processor.

What is claimed is:

1. A distributed computing environment update scheduling system for generating a schedule for executing an update task for updating an environment of a plurality of computer nodes to which a job including a task related to an application to be executed by a computer is allocated and executed by the plurality of computer nodes to apply update of a function provided to the application, wherein
a processor of the distributed computing environment update scheduling system is configured to:
monitor whether or not the function is updated;
determine, when detecting the update of the function, whether a running job and a standby job have compatibility that can be normally executed in the updated environment in the plurality of computer nodes; and
generate an execution schedule of the update task in the plurality of computer nodes based on a determination result as to whether the running job and the standby job have the compatibility.

2. The distributed computing environment update scheduling system according to claim 1, wherein the processor is further configured to select, from among the plurality of computer nodes, a priority execution computer node that interrupts the running job and executes the update task based on a determination result as to whether the running job and the standby job have the compatibility.

3. The distributed computing environment update scheduling system according to claim 2, wherein
the processor is further configured to:
calculate a required number of nodes of the computer node required to execute the running job and the standby job based on a resource status of each of the computer nodes;
calculate a ratio of the required number of nodes of each of the job having compatibility and the job having no compatibility among the running job and the standby job allocated to the plurality of computer nodes; and
select the priority execution computer node based on a ratio of the required number of nodes.

4. The distributed computing environment update scheduling system according to claim 2, wherein
the processor is further configured to:
continue execution of the running job in the computer node other than the priority execution computer node, and execute another job having no compatibility when the execution of the running job is completed;
execute, when the execution of all the jobs having no compatibility is completed, the update task; and
execute, when the execution of the update task is completed, another compatible job.

5. The distributed computing environment update scheduling system according to claim 2, wherein the processor is further configured to: change the allocation of the tasks included in the job having no compatibility allocated to the priority execution computer node to the computer nodes other than the priority execution computer node.

6. The distributed computing environment update scheduling system according to claim 1, wherein
the processor is further configured to:
determine whether a new task newly generated during execution of the update task in the plurality of computer nodes has the compatibility; and
generate an execution schedule of the new task in the plurality of computer nodes based on a determination result as to whether the new task has the compatibility.

7. The distributed computing environment update scheduling system according to claim 6, wherein
the processor is further configured to:
inquire, when the new task has no compatibility, a user whether to correct the new task to have the compatibility;
correct, upon accepting an instruction of the user to correct the new task to have the compatibility, the new task to have the compatibility, and generate an execution schedule so that the new task after the correction is executed in the computer node after the execution of the update task is completed; and
generate, upon accepting an instruction of the user not to correct the new task to have the compatibility, an execution schedule so that the update task is executed in the computer node in which execution has not been performed.

8. The distributed computing environment update scheduling system according to claim 1, wherein the computer is notified that the update of the environment of the computer node has been completed by execution of the update task.

9. The distributed computing environment update scheduling system according to claim 1, wherein the processor is further configured to: generate an execution schedule of the running job, the standby job, and the update task so as to level loads in the plurality of computer nodes.

10. The distributed computing environment update scheduling system according to claim 1, wherein the application is an application that executes machine learning processing.

11. A distributed computing environment update scheduling method for generating a schedule for executing an update task for updating an environment of a plurality of computer nodes to which a job including a task related to an application to be executed by a computer is allocated and executed by the plurality of computer nodes to apply update of a function provided to the application, wherein
a processor of the distributed computing environment update scheduling system is configured to:
monitor whether or not the function is updated;
determine, when detecting the update of the function, whether a running job and a standby job have compatibility that can be normally executed in the updated environment in the plurality of computer nodes; and
generate an execution schedule of the update task in the plurality of computer nodes based on a determination result as to whether the running job and the standby job have the compatibility.
